(19) United States
(12) Patent Application Publication
(10) Pub. No.: US 2021/0274524 A1
(43) Pub. Date: Sep. 2, 2021

(54) METHOD AND DEVICE USED IN NODES FOR WIRELESS COMMUNICATION

(71) Applicants: Zheng LIU, SHANGHAI (CN); Xiaobo ZHANG, SHANGHAI (CN); Lin YANG, SHANGHAI (CN)

(72) Inventors: Zheng LIU, SHANGHAI (CN); Xiaobo ZHANG, SHANGHAI (CN); Lin YANG, SHANGHAI (CN)

(73) Assignee: SHANGHAI LANGBO COMMUNICATION TECHNOLOGY COMPANY LIMITED, SHANGHAI (CN)

(21) Appl. No.: 17/325,231

(22) Filed: May 20, 2021

Related U.S. Application Data
(63) Continuation of application No. PCT/CN2019/118142, filed on Nov. 13, 2019.

(30) Foreign Application Priority Data
Nov. 23, 2018 (CN) 201811408148.3

(51) Int. Cl. H04W 72/12; H04W 72/04; H04L 1/00; H04L 1/18

(52) U.S. Cl. CPC H04W 72/1263; H04W 72/0453; H04W 72/0446; H04L 1/0061; H04L 1/1819; H04L 1/1896; H04L 1/0003

(57) ABSTRACT

The present disclosure a method and device used in communication nodes for wireless communication. A communication node receives X piece(s) of first-type information, transmits X radio signal(s) and transmits a first radio signal; a first bit block is used for generating any one of the X radio signal(s), and the first bit block is also used for generating the first radio signal; the X piece(s) of first-type information is(are) used for determining scheduling information of the X radio signal(s) respectively; the first communication node autonomously determines scheduling information of the first radio signal, a start time of a transmission of the first radio signal is later than an end time of a transmission of any one of the X radio signal(s); the scheduling information comprises at least one of an occupied time-frequency resource, an employed MCS or an employed RV. The present disclosure helps reduce header overhead and delay.

### CROSS REFERENCE TO RELATED APPLICATIONS

This application is a continuation of International Application No. PCT/CN2019/118142, filed Nov. 13, 2019, claims the priority benefit of Chinese Patent Application No. 201811408148.3, filed on Nov. 23, 2018, the full disclosure of which is incorporated herein by reference.

### BACKGROUND

### Technical Field

The present disclosure relates to transmission methods and devices in wireless communication systems, and in particular to a scheme and device of HARQ transmission in wireless communication.

### Related Art

Application scenarios of future wireless communication systems are becoming increasingly diversified, and different application scenarios have different performance demands on systems. In order to meet different performance requirements of various application scenarios, the 3^{rd} Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

In response to rapidly growing Vehicle-to-Everything (V2X) traffic, 3GPP has started standards setting and research work under the framework of NR. Currently, 3GPP has completed planning work targeting 5G V2X requirements and has included these requirements into standard TS22.886, where 3GPP identifies and defines 4 major Use Case Groups, covering cases of Vehicles Platooning, supporting Extended Sensors, Advanced Driving and Remote Driving. At 3GPP RAN #80 Plenary Session, the technical Study Item (SI) of NR V2X was approved.

### SUMMARY

Compared with the existing LIE V2X system, an NR V2X system has a distinctive feature of supporting both groupcast and unicast and the functionality of Hybrid Automatic Repeat Request (HARQ). When an NR V2X User Equipment (UE) is in coverage of a cell, working in a resource allocation mode controlled by a base station, a most direct way of supporting HARQ retransmission is to make the NR V2X UE report to the base station the HARQ-ACK feedback received by sidelink each time and then wait for the base station to schedule resources for retransmission, but such practice will largely increase the header overhead of a Uu interface and the transmission delay.

To address the above problem concerning HARQ retransmission in NR V2X, the present disclosure provides a solution. It should be noted that if no conflict is incurred, the embodiments of the UE in the present disclosure and the characteristics of the embodiments can be applied to a base station, and vice versa. And the embodiments in the present disclosure and the characteristics of the embodiments can be arbitrarily combined if there is no conflict.

The present disclosure discloses a method in a first communication node for wireless communication, comprising:

receiving X piece(s) of first-type information, X being a positive integer;

transmitting X radio signal(s); and

transmitting a first radio signal;

herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed Modulation and Coding Scheme (MCS) or an employed Redundancy Version (RV); any of the X piece(s) of first-type information is transmitted via a first-type air interface.

In one embodiment, when the X radio signal(s) is(are) transmitted through scheduling of the X piece(s) of first-type information, the first communication node is used for switching a Scheduled Mode, also called NR V2X Mode 1 of transmission of the first bit block to a UE Selected Mode, also called NR V2X Mode 2, thus reducing the impact on the Uu interface and the header overhead.

In one embodiment, the Scheduled Mode (also called NR V2X Mode 1) being converted to the UE Selected Mode (also called NR V2X Mode 2) in HARQ transmission leads to a balance between transmission reliability, delay performance and resource utilization.

According to one aspect of the present disclosure, the above method is characterized in further comprising:

receiving a first signaling;

herein, the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface.

In one embodiment, by introducing the first signaling, a base station (gNB or eNB) can control or enable/disable a mode conversion during HARQ retransmission, and then the base station will be able to control the mode employed in the HARQ retransmission taking consideration of factors ranging from network payload, interference to traffic delay, consequently, the network performance and flexibility will be improved systematically.

According to one aspect of the present disclosure, the above method is characterized in further comprising:

receiving X piece(s) of second-type information;

herein, the X piece(s) of second-type information corresponds (correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface.

According to one aspect of the present disclosure, the above method is characterized in further comprising:

transmitting X piece(s) of third-type information;

herein, the X piece(s) of third-type information corresponds (correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

According to one aspect of the present disclosure, the above method is characterized in further comprising:

transmitting X signaling(s) and a second signaling;

herein, the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

According to one aspect of the present disclosure, the above method is characterized in that the first bit block comprises K bit sub-blocks, K being a positive integer greater than 1, the K bit sub-blocks are used for generating each radio signal of the X radio signal(s), and only K1 bit sub-block(s) of the K bit sub-blocks is(are) used for generating the first radio signal, K1 being a positive integer less than K, any bit sub-block of the K1 bit sub-block(s) being one of the K bit sub-blocks.

In one embodiment, when performing Code Block Group (CBG)-based retransmission, the mode will be automatically switched to a UE Selected Mode, or called NR V2X Mode 2, which, by reducing the header overhead of the Uu interface and interactions between a transmitting UE's higher layer and physical layer, leads to lower complexity and delay.

The present disclosure discloses a method in a second communication node for wireless communication, comprising:

transmitting X piece(s) of first-type information, X being a positive integer;

herein, the X piece(s) of first-type information is(are respectively) used for determining scheduling information of the X radio signal(s); a first bit block is used for generating any radio signal of the X radio signal(s), and the first bit block is also used for generating the first radio signal, the first bit block comprising a positive integer number of bit(s); a transmitter of the first radio signal autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

According to one aspect of the present disclosure, the above method is characterized in further comprising:

transmitting a first signaling;

herein, the first signaling is used for indicating X, or the first signaling is used for indicating that a transmitter of the first radio signal autonomously determines the scheduling information of the first radio signal, or the first signaling is used for indicating X and that the transmitter of the first radio signal autonomously determines the scheduling information of the first radio signal; the first signaling is transmitted via the first-type air interface.

According to one aspect of the present disclosure, the above method is characterized in further comprising:

receiving X piece(s) of third-type information;

herein, the X piece(s) of third-type information corresponds (correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

According to one aspect of the present disclosure, the above method is characterized in that the first bit block comprises K bit sub-blocks, K being a positive integer greater than 1, the K bit sub-blocks are used for generating each radio signal of the X radio signal(s), and only K1 bit sub-block(s) of the K bit sub-blocks is(are) used for generating the first radio signal, K1 being a positive integer less than K, any bit sub-block of the K1 bit sub-block(s) being one of the K bit sub-blocks.

The present disclosure discloses a first communication node for wireless communication, comprising:

a first transceiver, receiving X piece(s) of first-type information, X being a positive integer;

a first transmitter, transmitting X radio signal(s); and

a second transmitter, transmitting a first radio signal;

herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed Modulation and Coding Scheme (MCS) or an employed Redundancy Version (RV); any of the X piece(s) of first-type information is transmitted via a first-type air interface.

The present disclosure discloses a second communication node for wireless communication, comprising:

a second transceiver, transmitting X piece(s) of first-type information, X being a positive integer;

herein, the X piece(s) of first-type information is(are respectively) used for determining scheduling information of the X radio signal(s); a first bit block is used for generating any radio signal of the X radio signal(s), and the first bit block is also used for generating the first radio signal, the first bit block comprising a positive integer number of bit(s); a transmitter of the first radio signal autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, compared with the conventional way of directly using a base station in resource configurations for each HARQ retransmission, the method proposed by the present disclosure is advantageous in the following aspects:

By employing the method, an NR V2X UE can convert a Scheduled Mode or NR V2X Mode 1 of HARQ retransmission to a UE Selected Mode or NR V2X Mode 2, thereby reducing the impact on the Uu interface and the header overhead.

During HARQ retransmission, the Scheduled Mode, or NR V2X Mode 1, is converted to a UE Selected Mode, or NR V2X Mode 2, thus achieving a balance between transmission reliability, delay performance and resource utilization.

The method herein ensures that a base station (gNB or eNB) is capable of controlling, enabling/disabling the mode conversion in the HARQ retransmission process, so that the base station can have a comprehensive consideration of how to control the mode of HARQ retransmission in accordance with network payload, interference, traffic delay and other factors, thus improving the network performance and flexibility in a systematic manner.

By employing the method, the Code Block Group (CBG)-based retransmission can be automatically switched to the UE Selected Mode, or NR V2X Mode 2, which further reduces the header overhead of the Uu interface and also decreases interactions between a higher layer and a physical layer of the transmitting UE, thus reducing the complexity and delay.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of transmitting X piece(s) of first-type information, X radio signal(s) and a first radio signal according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication node and a second communication node according to one embodiment of the present disclosure.

FIG. 5 illustrates a schematic diagram of a first communication node in communication with another UE according to one embodiment of the present disclosure.

FIG. 6 illustrates a flowchart of radio signal transmission according to one embodiment of the present disclosure.

FIG. 7 illustrates a flowchart of radio signal transmission according to another embodiment of the present disclosure.

FIG. 8 illustrates a schematic diagram of a first signaling according to one embodiment of the present disclosure.

FIG. 9 illustrates a schematic diagram of relations of X piece(s) of second-type information, X piece(s) of third-type information and X radio signal(s) according to one embodiment of the present disclosure.

FIG. 10 illustrates a schematic diagram of relations of X signaling(s), X radio signal(s), a second signaling and a first radio signal according to one embodiment of the present disclosure.

FIG. 11 illustrates a schematic diagram of relations of X radio signal(s) and a first radio signal according to one embodiment of the present disclosure.

FIG. 12 illustrates a structure block diagram of a processing device in a first communication node according to one embodiment of the present disclosure.

FIG. 13 illustrates a structure block diagram of a processing device in a second communication node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

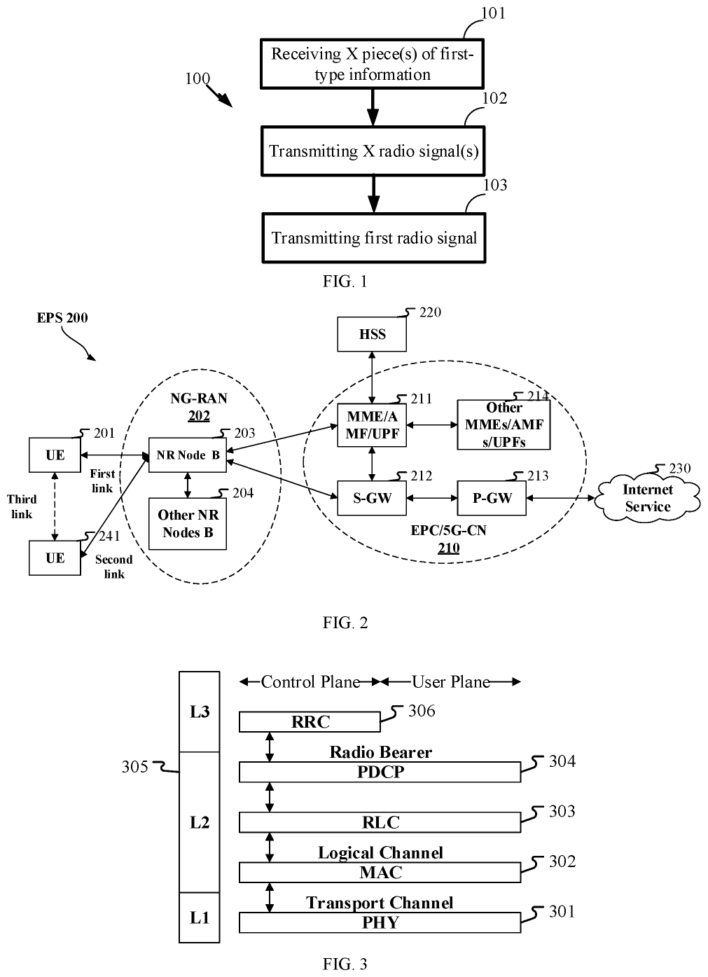

Embodiment 1 illustrates a flowchart of transmitting X piece(s) of first-type information, X radio signal(s) and a first radio signal according to one embodiment of the present disclosure, as shown in FIG. 1. In FIG. 1, each box represents a step. It should be particularly stressed that the sequence of how each box is arranged in the figure does not necessarily represent a chronological order of the steps respectively marked by these boxes.

In Embodiment 1, the first communication node in the present disclosure receives X piece(s) of first-type information, X being a positive integer; transmits X radio signal(s); and transmits a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the first communication node is a UE.

In one embodiment, the first communication node is vehicle-mounted equipment.

In one embodiment, the first communication node is a UE available for V2X communication.

In one embodiment, X is equal to 1.

In one embodiment, X is greater than 1.

In one embodiment, a value of X is pre-defined.

In one embodiment, a value of X is fixed.

In one embodiment, a value of X is variable.

In one embodiment, a value of X is configurable.

In one embodiment, any one of the X piece(s) of first-type information comprises physical-layer information.

In one embodiment, any one of the X piece(s) of first-type information comprises higher-layer information.

In one embodiment, any one of the X piece(s) of first-type information is transmitted by a physical-layer signaling.

In one embodiment, any one of the X piece(s) of first-type information is transmitted by a higher-layer signaling.

In one embodiment, any one of the X piece(s) of first-type information comprises all or part of a piece of higher-layer information.

In one embodiment, any one of the X piece(s) of first-type information comprises all or part of a piece of physical-layer information.

In one embodiment, any one of the X piece(s) of first-type information is transmitted through a Downlink Shared Channel (DL-SCH).

In one embodiment, any one of the X piece(s) of first-type information is transmitted through a Physical Downlink Shared Channel (PDSCH).

In one embodiment, any one of the X piece(s) of first-type information is broadcast.

In one embodiment, any one of the X piece(s) of first-type information is unicast.

In one embodiment, any one of the X piece(s) of first-type information is Cell Specific.

In one embodiment, any one of the X piece(s) of first-type information is UE-specific.

In one embodiment, any one of the X piece(s) of first-type information is transmitted through a Physical Downlink Control Channel (PDCCH).

In one embodiment, any one of the X piece(s) of first-type information comprises all or part of fields of a Downlink Control Information (DCI) signaling.

In one embodiment, any one of the X piece(s) of first-type information comprises all or part of fields of a DCI signaling used for sidelink.

In one embodiment, any one of the X piece(s) of first-type information comprises all or part of fields of a DCI Format 3.

In one embodiment, contents respectively carried by any two of the X pieces of first-type information are different, X being greater than 1.

In one embodiment, there are two of the X pieces of first-type information that carry same contents, X being greater than 1.

In one embodiment, among the X pieces of first-type information there are two pieces of first-type information respectively comprising one field that carry same contents, X being greater than 1.

In one embodiment, among the X pieces of first-type information any two pieces of first-type information respectively comprise one field that carry same contents, X being greater than 1.

In one embodiment, among the X pieces of first-type information any two pieces of first-type information respectively comprise one field for indicating Hybrid Automatic Repeat Request (HARQ) Process that carry same contents, X being greater than 1.

In one embodiment, any two of the X pieces of first-type information are for a same HARQ Process, X being greater than 1.

In one embodiment, start times of transmission of the X pieces of first-type information and start times of transmission of the X radio signals are interleaved in time domain.

In one embodiment, the phrase that “the X piece(s) of first-type information is(are respectively) used for determining scheduling information of the X radio signal(s)” includes a meaning that the X piece(s) of first-type information is(are respectively) used by the first communication node for determining scheduling information of the X radio signal(s).

In one embodiment, the phrase that “the X piece(s) of first-type information is(are respectively) used for determining scheduling information of the X radio signal(s)” includes a meaning that the X piece(s) of first-type information is(are respectively) used for directly indicating scheduling information of the X radio signal(s).

In one embodiment, the phrase that “the X piece(s) of first-type information is(are respectively) used for determining scheduling information of the X radio signal(s)” includes a meaning that the X piece(s) of first-type information is(are respectively) used for indirectly indicating scheduling information of the X radio signal(s).

In one embodiment, the phrase that “the X piece(s) of first-type information is(are respectively) used for determining scheduling information of the X radio signal(s)” includes a meaning that the X piece(s) of first-type information is(are respectively) used for explicitly indicating scheduling information of the X radio signal(s).

In one embodiment, the phrase that “the X piece(s) of first-type information is(are respectively) used for determining scheduling information of the X radio signal(s)” includes a meaning that the X piece(s) of first-type information is(are respectively) used for implicitly indicating scheduling information of the X radio signal(s).

In one embodiment, the X radio signals all belong to a same Hybrid Automatic Repeat Request (HARQ) Process.

In one embodiment, any of the X radio signal(s) can be used for combined decoding of the first bit block.

In one embodiment, any of the X radio signal(s) is not received correctly.

In one embodiment, any of the X radio signal(s) is not decoded correctly.

In one embodiment, Cyclic Redundancy Check (CRC) of any of the X radio signal(s) fails to be passed.

In one embodiment, a radio signal with an earliest start time of transmission among the X radio signals is an initial transmission of the first bit block.

In one embodiment, any radio signal among the X radio signals other than a radio signal with an earliest start time of transmission is a retransmission of the first bit block, X being greater than 1.

In one embodiment, any two of the X radio signals have different start times of transmission, X being greater than 1.

In one embodiment, any of the X radio signal(s) is transmitted through a Sidelink Shared Channel (SL-SCH).

In one embodiment, any of the X radio signal(s) is transmitted through Sidelink.

In one embodiment, any of the X radio signal(s) is transmitted from a PC5 interface.

In one embodiment, any of the X radio signal(s) is unicast.

In one embodiment, any of the X radio signal(s) is groupcast.

In one embodiment, any of the X radio signal(s) is transmitted through a Physical Sidelink Shared Channel (PSSCH).

In one embodiment, the X radio signals are received by a same receiver.

In one embodiment, the X radio signals are received by a same target receiver.

In one embodiment, among the X radio signals there are two radio signals of unequal Redundancy Versions, X being greater than 1.

In one embodiment, among the X radio signals there are two radio signals of an equal Redundancy Version, X being greater than 1.

In one embodiment, a transmitter of the X piece(s) of first-type information is different from a target receiver of the X radio signal(s).

In one embodiment, a transmitter of the X piece(s) of first-type information is a base station.

In one embodiment, a transmitter of the X piece(s) of first-type information is a gNB.

In one embodiment, a target receiver of the X radio signal(s) is a UE.

In one embodiment, a target receiver of the first radio signal is the same as a target receiver of the X radio signal(s).

In one embodiment, a target receiver of the first radio signal is a UE.

In one embodiment, the X radio signal(s) is(are) transmitted through the second-type air interface in the present disclosure.

In one embodiment, the X radio signal(s) is(are) transmitted through a PC5 interface.

In one embodiment, the X radio signal(s) is(are) transmitted through Sidelink.

In one embodiment, the first radio signal is transmitted through the second-type air interface in the present disclosure.

In one embodiment, the first radio signal is transmitted through a PC5 interface.

In one embodiment, the first radio signal is transmitted through Sidelink.

In one embodiment, the first radio signal can be used for combined decoding of the first bit block.

In one embodiment, the first radio signal is a retransmission of all or part of bits comprised in the first bit block.

In one embodiment, the first radio signal is transmitted through an SL-SCH.

In one embodiment, the first radio signal is transmitted through Sidelink.

In one embodiment, the first radio signal is transmitted by a PC5 interface.

In one embodiment, the first radio signal is unicast.

In one embodiment, the first radio signal is groupcast.

In one embodiment, the first radio signal is transmitted through a PSSCH.

In one embodiment, the first bit block is a Transport Block (TB).

In one embodiment, the first bit block is obtained by a TB through CRC Insertion.

In one embodiment, any of the X radio signal(s) is generated by the first bit block sequentially through Channel Coding, Rate Matching, Scrambling, Modulation, Layer Mapping, Precoding, Mapping to Virtual Resource Blocks, and Mapping from Virtual to Physical Resource Blocks, OFDM Baseband Signal Generation as well as Modulation and Upconversion.

In one embodiment, any of the X radio signal(s) is generated by the first bit block sequentially through CRC Insertion, Channel Coding, Rate Matching, Scrambling, Modulation, Layer Mapping, Precoding, Mapping to Virtual Resource Blocks and Mapping from Virtual to Physical Resource Blocks, OFDM Baseband Signal Generation as well as Modulation and Upconversion.

In one embodiment, any of the X radio signal(s) is generated by the first bit block sequentially through CRC Insertion, Segmentation, Code-Block-level (CB-level) CRC Insertion, Channel Coding, Rate Matching, Concatenation and Scrambling, Modulation, Layer Mapping, Precoding, Mapping to Virtual Resource Blocks, and

Mapping from Virtual to Physical Resource Blocks, OFDM Baseband Signal Generation, as well as Modulation and Upconversion.

In one embodiment, any of the X radio signal(s) is generated by the first bit block sequentially through Segmentation, CB-level CRC Insertion, Channel Coding, Rate Matching, Concatenation, Scrambling and Modulation, Layer Mapping, Precoding, Mapping to Virtual Resource Blocks and Mapping from Virtual to Physical Resource Blocks, OFDM Baseband Signal Generation as well as Modulation and Upconversion.

In one embodiment, any of the X radio signal(s) is generated by the first bit block sequentially through CRC Insertion, Channel Coding, Rate Matching, Scrambling, Modulation, Layer Mapping, Transform Precoding, and Precoding, Mapping to Virtual Resource Blocks, Mapping from Virtual to Physical Resource Blocks and OFDM Baseband Signal Generation, as well as Modulation and Upconversion.

In one embodiment, any of the X radio signal(s) is generated by the first bit block sequentially through Channel Coding, Rate Matching, Scrambling, Modulation, Layer Mapping, Transform Precoding and Precoding, Mapping to Virtual Resource Blocks, Mapping from Virtual to Physical Resource Blocks, and OFDM Baseband Signal Generation as well as Modulation and Upconversion.

In one embodiment, any of the X radio signal(s) is generated by the first bit block sequentially through CRC Insertion, Segmentation, CB-level CRC Insertion, Channel Coding, Rate Matching, Concatenation, Scrambling, Modulation and Layer Mapping, Transform Precoding, Precoding, Mapping to Virtual Resource Blocks, and Mapping from Virtual to Physical Resource Blocks, OFDM Baseband Signal Generation and Modulation and Upconversion.

In one embodiment, any of the X radio signal(s) is generated by the first bit block sequentially through Segmentation, CB-level CRC Insertion, Channel Coding, Rate Matching, Concatenation, Scrambling, Modulation, and Layer Mapping, Transform Precoding, Precoding, Mapping to Virtual Resource Blocks, Mapping from Virtual to Physical Resource Blocks, OFDM Baseband Signal Generation, as well as Modulation and Upconversion.

In one embodiment, the first radio signal is obtained by the first bit block sequentially through Channel Coding, Rate Matching, Scrambling, Modulation, Layer Mapping, Precoding, Mapping to Virtual Resource Blocks, and Mapping from Virtual to Physical Resource Blocks, OFDM Baseband Signal Generation as well as Modulation and Upconversion.

In one embodiment, the first radio signal is obtained by the first bit block sequentially through CRC Insertion, Channel Coding, Rate Matching, Scrambling, Modulation, Layer Mapping, Precoding, Mapping to Virtual Resource Blocks and Mapping from Virtual to Physical Resource Blocks, OFDM Baseband Signal Generation as well as Modulation and Upconversion.

In one embodiment, the first radio signal is obtained by the first bit block sequentially through CRC Insertion, Segmentation, Code-Block-level (CB-level) CRC Insertion, Channel Coding, Rate Matching, Concatenation and Scrambling, Modulation, Layer Mapping, Precoding, Mapping to Virtual Resource Blocks, and Mapping from Virtual to Physical Resource Blocks, OFDM Baseband Signal Generation, as well as Modulation and Upconversion.

In one embodiment, the first radio signal is obtained by the first bit block sequentially through Segmentation, CB-level CRC Insertion, Channel Coding, Rate Matching, Concatenation, Scrambling and Modulation, Layer Mapping, Precoding, Mapping to Virtual Resource Blocks and Mapping from Virtual to Physical Resource Blocks, OFDM Baseband Signal Generation as well as Modulation and Upconversion.

In one embodiment, the first radio signal is obtained by the first bit block sequentially through CRC Insertion, Channel Coding, Rate Matching, Scrambling, Modulation, Layer Mapping, Transform Precoding, and Precoding, Mapping to Virtual Resource Blocks, Mapping from Virtual to Physical Resource Blocks and OFDM Baseband Signal Generation, as well as Modulation and Upconversion.

In one embodiment, the first radio signal is obtained by the first bit block sequentially through Channel Coding, Rate Matching, Scrambling, Modulation, Layer Mapping, Transform Precoding and Precoding, Mapping to Virtual Resource Blocks, Mapping from Virtual to Physical Resource Blocks, and OFDM Baseband Signal Generation as well as Modulation and Upconversion.

In one embodiment, the first radio signal is obtained by the first bit block sequentially through CRC Insertion, Segmentation, CB-level CRC Insertion, Channel Coding, Rate Matching, Concatenation, Scrambling, Modulation and Layer Mapping, Transform Precoding, Precoding, Mapping to Virtual Resource Blocks, and Mapping from Virtual to Physical Resource Blocks, OFDM Baseband Signal Generation and Modulation and Upconversion.

In one embodiment, the first radio signal is obtained by the first bit block sequentially through Segmentation, CB-level CRC Insertion, Channel Coding, Rate Matching, Concatenation, Scrambling, Modulation, and Layer Mapping, Transform Precoding, Precoding, Mapping to Virtual Resource Blocks, Mapping from Virtual to Physical Resource Blocks, OFDM Baseband Signal Generation, as well as Modulation and Upconversion.

In one embodiment, the phrase that “the scheduling information comprises at least one of an occupied time-frequency resource, an employed MCS or an employed RV” includes a meaning that the scheduling information comprises an occupied time-frequency resource, an employed MCS and an employed RV.

In one embodiment, the phrase that “the scheduling information comprises at least one of an occupied time-frequency resource, an employed MCS or an employed RV” includes a meaning that the scheduling information comprises one of an occupied time-frequency resource, an employed MCS and an employed RV.

In one embodiment, the phrase that “the scheduling information comprises at least one of an occupied time-frequency resource, an employed MCS or an employed RV” includes a meaning that the scheduling information comprises an occupied time-frequency resource and an employed MCS.

In one embodiment, the phrase that “the scheduling information comprises at least one of an occupied time-frequency resource, an employed MCS or an employed RV” includes a meaning that the scheduling information comprises an occupied time-frequency resource and an employed RV.

In one embodiment, the phrase that “the scheduling information comprises at least one of an occupied time-frequency resource, an employed MCS or an employed RV” includes a meaning that the scheduling information comprises one of an employed MCS and an employed RV.

In one embodiment, the first-type air interface is a Uu interface.

In one embodiment, the first-type air interface is a radio interface between a base station and a UE.

In one embodiment, the first-type air interface is a radio interface between a gNB and a UE.

### Embodiment 2

Embodiment 2 illustrates a schematic diagram of a network architecture according to the present disclosure, as shown in FIG. 2. FIG. 2 is a diagram illustrating a network architecture 200 of NR 5G, Long-Term Evolution (LIE), and Long-Term Evolution Advanced (LTE-A) systems. The NR 5G or LTE network architecture 200 may be called an Evolved Packet System (EPS) 200, which may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present disclosure can be extended to networks providing circuit switching services. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In V2X networks, the gNB 203 can be a base station, a terrestrial base station relayed by satellite or a Road Side Unit (RSU). The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPS), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client, an automobile, or a V2X device or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMES/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises operator-compatible IP services, specifically including Internet, Intranet, IP Multimedia Subsystem (IMS) and Packet Switching (PS) Streaming services.

In one embodiment, the UE201 corresponds to the first communication node in the present disclosure.

In one embodiment, the UE201 supports transmission in sidelink.

In one embodiment, the UE201 supports a PC5 interface.

In one embodiment, the UE201 supports Vehicle-to-Everything.

In one embodiment, the UE201 supports V2X traffics.

In one embodiment, the gNB203 corresponds to the second communication node in the present disclosure.

In one embodiment, the gNB203 supports Vehicle-to-Everything.

In one embodiment, the gNB203 supports V2X traffics.

### Embodiment 3

Embodiment 3 illustrates a schematic diagram of one embodiment of a radio protocol architecture of a user plane and a control plane according to the present disclosure, as shown in FIG. 3. FIG. 3 is a schematic diagram illustrating a radio protocol architecture of a user plane and a control plane. In FIG. 3, the radio protocol architecture for a first communication node (UE or RSU in V2X) and a second communication node (gNB or eNB), or between two UEs is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of the link between the first communication node and the second communication node and the link between UEs via the PHY 301. In the user plane, L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. Although not described in FIG. 3, the first communication node may comprise several higher-layers above the L2 305, such as a network layer (i.e., IP layer) terminated at a P-GW 213 of the network side and an application layer terminated at the other side of the connection (i.e., a peer UE, a server, etc.). The PDCP sublayer 304 provides multiplexing among variable radio bearers and logical channels. The PDCP sublayer 304 also provides a header compression for a higher-layer packet so as to reduce radio transmission overhead. The PDCP sublayer 304 provides security by encrypting a packet and provides support for handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource blocks) in a cell. The MAC sublayer 302 is also in charge of HARQ operation. In the control plane, the radio protocol architecture used for the first communication node and the second communication node is almost the same as the radio protocol architecture in the user plane on the PHY 301 and the L2 305, but there is no header compression for the control plane. The control plane also comprises a Radio Resource Control (RRC) sublayer 306 in the layer 3 (L3). The RRC sublayer 306 is responsible for acquiring radio resources (i.e., radio bearer) and configuring the lower layer using an RRC signaling between the second communication node and the first communication node.

In one embodiment, the radio protocol architecture in FIG. 3 is applicable to the first communication node in the present disclosure.

In one embodiment, the radio protocol architecture in FIG. 3 is applicable to the second communication node in the present disclosure.

In one embodiment, any of the X piece(s) of first-type information in the present disclosure is generated by the RRC 306.

In one embodiment, any of the X piece(s) of first-type information in the present disclosure is generated by the MAC 302.

In one embodiment, any of the X piece(s) of first-type information in the present disclosure is generated by the PHY 301.

In one embodiment, any of the X radio signal(s) in the present disclosure is generated by the RRC 306.

In one embodiment, any of the X radio signal(s) in the present disclosure is generated by the MAC 302.

In one embodiment, any of the X radio signal(s) in the present disclosure is generated by the PHY 301.

In one embodiment, the first radio signal in the present disclosure is generated by the RRC 306.

In one embodiment, the first radio signal in the present disclosure is generated by the MAC 302.

In one embodiment, the first radio signal in the present disclosure is generated by the PHY 301.

In one embodiment, the first signaling in the present disclosure is generated by the RRC 306.

In one embodiment, the first signaling in the present disclosure is generated by the MAC 302.

In one embodiment, the first signaling in the present disclosure is generated by the PHY 301.

In one embodiment, any of the X piece(s) of second-type information in the present disclosure is generated by the RRC 306.

In one embodiment, any of the X piece(s) of second-type information in the present disclosure is generated by the MAC 302.

In one embodiment, any of the X piece(s) of second-type information in the present disclosure is generated by the PHY 301.

In one embodiment, any of the X piece(s) of third-type information in the present disclosure is generated by the RRC 306.

In one embodiment, any of the X piece(s) of third-type information in the present disclosure is generated by the MAC 302.

In one embodiment, any of the X piece(s) of third-type information in the present disclosure is generated by the PHY 301.

In one embodiment, any of the X signaling(s) in the present disclosure is generated by the RRC 306.

In one embodiment, any of the X signaling(s) in the present disclosure is generated by the MAC 302.

In one embodiment, any of the X signaling(s) in the present disclosure is generated by the PHY 301.

In one embodiment, the second signaling in the present disclosure is generated by the RRC 306.

In one embodiment, the second signaling in the present disclosure is generated by the MAC 302.

In one embodiment, the second signaling in the present disclosure is generated by the PHY 301.

### Embodiment 4

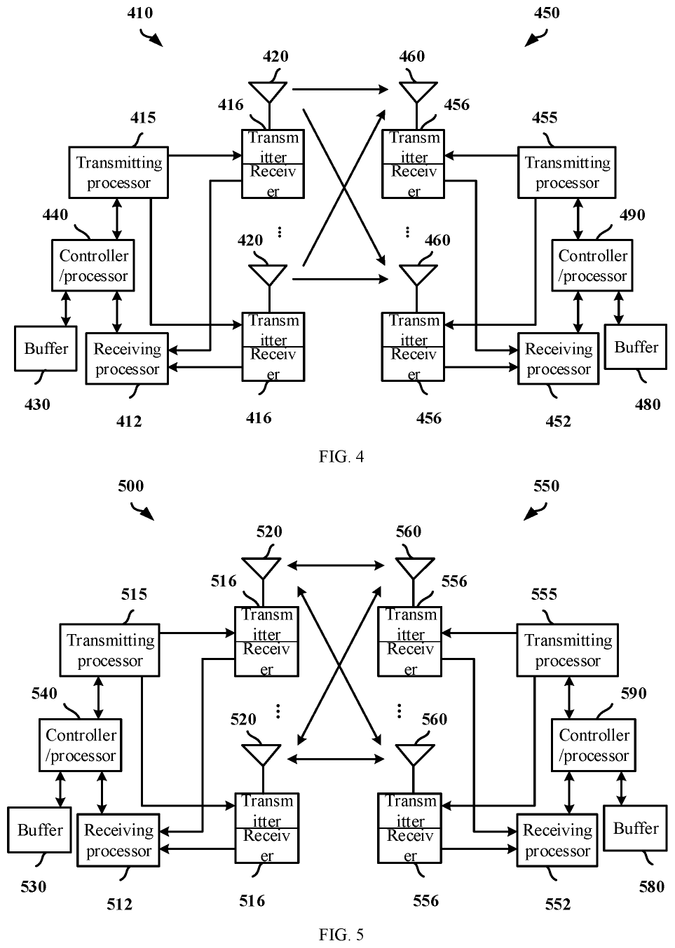

Embodiment 4 illustrates a schematic diagram of a first communication node and a second communication node, as shown in FIG. 4.

A first communication node (450) comprises a controller/processor 490, a memory 480, a receiving processor 452, a transmitter/receiver 456, a transmitting processor 455 and a data source 467, wherein the transmitter/receiver 456 comprises an antenna 460. The data source 467 provides a higher-layer packet to the controller/processor 490, the controller/processor 490 provides header compression and decompression, encryption and decryption, packet segmentation and reordering as well as multiplexing and demultiplexing between a logical channel and a transport channel, so as to implement the L2 layer protocol for the user plane and the control plane. The higher-layer packet may comprise data or control information, such as a DL-SCH, a UL-SCH or a SL-SCH. The transmitting processor 455 performs various signal transmitting processing functions used for the L1 layer (i.e., PHY), including coding, interleaving, scrambling, modulation, power control/allocation, precoding and generation of physical layer control signaling. The receiving processor 452 performs various signal receiving processing functions used for the L1 layer (i.e., PHY), including decoding, deinterleaving, descrambling, demodulation, de-precoding and extraction of physical layer control signaling. The transmitter 456 is used to convert a baseband signal provided by the transmitting processor 455 into a Radio Frequency (RF) signal to be transmitted via the antenna 460, and the receiver 456 is configured to convert the RF signal received via the antenna 460 into a baseband signal to be provided to the receiving processor 452.

The second communication node (410) may comprise a controller/processor 440, a memory 430, a receiving processor 412, a transmitter/receiver 416 and a transmitting processor 415, wherein the transmitter/receiver 416 comprises an antenna 420. A higher-layer packet is provided to the controller/processor 440; the controller/processor 440 provides header compression and decompression, encryption and decryption, packet segmentation and reordering as well as multiplexing and demultiplexing between a logical channel and a transport channel, so as to implement the L2 layer protocol for the user plane and the control plane. The higher-layer packet may comprise data or control information, such as a DL-SCH or a UL-SCH. The transmitting processor 415 performs various signal transmitting processing functions used for the L1 layer (i.e., PHY), including coding, interleaving, scrambling, modulation, power control/allocation, precoding and physical layer signaling (i.e., synchronization signal, reference signal, etc.) generation. The receiving processor 412 performs various signal receiving processing functions used for the L1 layer (i.e., PHY), including decoding, deinterleaving, demodulation, de-precoding and physical layer signaling extraction. The transmitter 416 is configured to convert a baseband signal provided by the transmitting processor 415 into an RF signal to be transmitted via the antenna 420, and the receiver 416 is configured to convert the RF signal received via the antenna 420 into a baseband signal to be provided to the receiving processor 412.

In Downlink (DL) transmission, a higher-layer packet (for example, higher-layer information comprised in the X piece(s) of first-type information and the first signaling) is provided to the controller/processor 440. The controller/processor 440 implements the functionality of the L2 layer. In DL, the controller/processor 440 provides packet compression, encryption, packet segmentation and reordering and multiplexing between a logical channel and a transport channel, as well as radio resources allocation of the first communication node 450 based on various priorities. The controller/processor 440 is also in charge of HARQ operation, a retransmission of a lost packet and a signaling to the first communication node 450, for instance, the X piece(s) of first-type information and the higher-layer information comprised in the first signaling are generated in the controller/processor 440. The transmitting processor 415 performs various signal processing functions used for the L1 layer (that is, PHY), including coding, interleaving, scrambling, modulation, power control/allocation, precoding and physical layer control signaling generation, which means that physical layer signals of the X piece(s) of first-type information and the first signaling are all generated in the transmitting processor 415. Modulation symbols are divided into parallel streams and each of them is mapped into a corresponding multicarrier subcarrier and/or multicarrier symbol. Then the streams are mapped from the transmitting processor 415 to the antenna 420 through the transmitter 416 and transmitted in the form of RF signals. Channels corresponding to the X piece(s) of first-type information and the first signaling in the present disclosure are mapped by the transmitting processor 415 to a target radio resource and then mapped to the antenna 420 via the transmitter 416 to be transmitted in the form of radio frequency signals. At the receiver side, each receiver 456 receives an RF signal via a corresponding antenna 460, recovers baseband information modulated into the RF carrier and then provides the baseband information to the receiving processor 452. The receiving processor 452 performs various signal receiving processing functions of the L1 layer. The signal receiving processing functions include receiving physical-layer signals of the X piece(s) of first-type information and the first signaling in the present disclosure. Multicarrier symbols in multicarrier symbol streams are demodulated based on varied modulation schemes (i.e., BPSK, QPSK), and are then subjected to descrambling, decoding and deinterleaving so as to recover data or control signals transmitted by the second communication node 410 in a physical channel. After that the data or control signal is provide to the controller/processor 490. The controller/processor 490 implements the functionality of the L2 layer. The controller/processor 490 interprets the X piece(s) of first-type information and higher-layer information comprised in the first signaling in the present disclosure. The controller/processor 490 can be associated with the memory 480 that stores program codes and data. The memory 480 can be called a computer readable medium.

In Uplink (UL) transmission, the data source 467 is used to provide higher-layer data to the controller/processor 490. The data source 467 represents all protocol layers above the L2 layer. The controller/processor 490, based on radio resources allocation of the second communication node 410, provides header compression, encryption, packet segmentation and reordering and a multiplexing between a logical channel and a transport channel, so as to implement the L2 layer protocol for the user plane and the control plane. The controller/processor 490 is also in charge of HARQ operation, a retransmission of a lost packet and a signaling to the second communication node 410. The transmitting processor 455 performs various signal transmitting processing functions used for the L1 layer (that is, PHY), for example, the X piece(s) of third-type information in the present disclosure is(are) generated by the transmitting processor 455. The signal transmitting processing functions include coding and interleaving so as to promote Forward Error Correction (FEC) at the UE 450 side and also modulation of baseband signals according to each modulation scheme (for example, BPSK, QPSK, etc.). The modulation symbols are divided into parallel streams and each stream is mapped into a corresponding multicarrier subcarrier and/or multicarrier symbol. The symbol streams are later mapped to the antenna 460 via the transmitter 456 and transmitted in the form of RF signals. The receiver 416 receives an RF signal via a corresponding antenna 420; each receiver 416 recovers baseband information modulated onto an RF carrier, and provides the baseband information to the receiving processor 412. The receiving processor 412 performs various signal receiving processing functions used for the L1 layer (that is, PHY), including acquiring multicarrier symbol streams, and then demodulating multicarrier symbols in multicarrier symbol streams based on various modulation schemes (i.e., BPSK, QPSK, etc.), after which the multicarrier symbols are decoded and deinterleaved to recover data and/or control signals originally transmitted by the first communication node 450 in a physical layer channel, for instance, the reception of X piece(s) of third-type information and performing channel estimation are completed in the receiving processor 412. The data and/or control signals are later provided to the controller/processor 440. The controller/processor 440 implements the L2 functionality. The controller/processor 440 may be associated with the memory 430 that stores program codes and data. The memory 430 may be computer readable medium.

In one embodiment, the first communication node 450 comprises at least one processor and at least one memory. The at least one memory includes computer program codes. The at least one memory and the computer program codes are configured to be used in collaboration with the at least one processor. The first communication node 450 at least receives X piece(s) of first-type information, X being a positive integer; transmits X radio signal(s); and transmits a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the first communication node 450 comprises a memory that stores a computer readable instruction program. The computer readable instruction program generates actions when executed by at least one processor. The actions include: receiving X piece(s) of first-type information, X being a positive integer; transmitting X radio signal(s); and transmitting a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the second communication node 410 comprises at least one processor and at least one memory. The at least one memory includes computer program codes. The at least one memory and the computer program codes are configured to be used in collaboration with the at least one processor. The second communication node 410 at least transmits X piece(s) of first-type information, X being a positive integer; herein, the X piece(s) of first-type information is(are respectively) used for determining scheduling information of the X radio signal(s); a first bit block is used for generating any radio signal of the X radio signal(s), and the first bit block is also used for generating the first radio signal, the first bit block comprising a positive integer number of bit(s); a transmitter of the first radio signal autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the second communication node 410 comprises a memory that stores a computer readable instruction program. The computer readable instruction program generates actions when executed by at least one processor. The actions include: transmitting X piece(s) of first-type information, X being a positive integer; herein, the X piece(s) of first-type information is(are respectively) used for determining scheduling information of the X radio signal(s); a first bit block is used for generating any radio signal of the X radio signal(s), and the first bit block is also used for generating the first radio signal, the first bit block comprising a positive integer number of bit(s); a transmitter of the first radio signal autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the receiver 456 (comprising the antenna 460), the receiving processor 452 and the controller/processor 490 are used for receiving the X piece(s) of first-type information in the present disclosure.

In one embodiment, the receiver 456 (comprising the antenna 460), the receiving processor 452 and the controller/processor 490 are used for receiving the first signaling in the present disclosure.

In one embodiment, the transmitter 416 (comprising the antenna 420), the transmitting processor 415 and the controller/processor 440 are used for transmitting the X piece(s) of first-type information in the present disclosure.

In one embodiment, the transmitter 416 (comprising the antenna 420), the transmitting processor 415 and the controller/processor 440 are used for transmitting the first signaling in the present disclosure.

### Embodiment 5

Embodiment 5 illustrates a schematic diagram of a first communication node in communication with another UE according to one embodiment of the present disclosure, as shown in FIG. 5.

A first communication node (500) comprises a controller/processor 540, a memory 530, a receiving processor 512, a transmitter/receiver 516 comprising an antenna 520 and a transmitting processor 515. A data source provides a higher layer packet to the controller/processor 540, and the controller/processor 540 provides header compression and decompression, encryption and decryption, packet segmentation and reordering, as well as multiplexing and de-multiplexing between logical and transport channels, so as to implement the L2 protocols, the higher layer packet can comprise data or control information, such as an SL-SCH. The transmitting processor 515 provides various signal transmitting processing functions used for the L1 (that is, PHY), including coding, interleaving, scrambling, modulation, power control/allocation, precoding and physical layer control signaling generation. The receiving processor 512 provides various signal receiving processing functions used for the L1 (that is, PHY), including decoding, de-interleaving, de-scrambling, demodulation, de-precoding and physical layer control signaling extraction. The transmitter 516 is used to convert a baseband signal provided from the transmitting processor 515 into an RF signal to be transmitted by the antenna 520, and then the receiver 516 is used to convert the RF signal received by the antenna 520 into a baseband signal and provide the baseband signal to the receiving processor 512. The composition of another UE is the same as the counterpart in the first communication node 500.

In sidelink transmission, a higher-layer packet (such as the X radio signal(s) and the first radio signal in the present disclosure) is provided to the controller/processor 540, and the controller/processor 540 implements the functions of the L2. In sidelink transmission, the controller/processor 540 is also responsible for HARQ operation (if supportable), repeated transmissions, and a signaling to the UE 550. The transmitting processor provides various signal processing functions used for the L1 (that is, PHY), including coding, interleaving, scrambling, modulation, power control/allocation, precoding and physical layer control signaling generation. The physical layer signals of the X radio signal(s) and the first radio signal, the X signaling(s) and the first signaling in the present disclosure are all generated by the transmitting processor 515. Modulation symbols are divided into parallel streams and each stream is mapped to the antenna 520 by the transmitter 516 to be transmitted in the form of an RF signal. At the receiver end, each receiver 556 receives a RF signal via a corresponding antenna 560, recovers baseband information modulated onto radio frequency carriers and then provides the baseband information to the receiving processor 552. The receiving processor 552 provides various signal receiving processing functions of the L1. The signal receiving processing functions include receiving the X signaling(s) and the first signaling, as well as physical layer signals of the X radio signal(s) and the first radio signal in the present disclosure, demodulating of multicarrier symbols in multicarrier symbol streams based on each modulation scheme (e.g., BPSK, QPSK), de-scrambling, decoding and de-interleaving so as to recover data or control signal transmitted by the first communication node 500, and providing the data and control signal to the controller/processor 590. The controller/processor 590 implements the L2 functionality, and also interprets the X radio signal(s) and the first radio signal in the present disclosure. The controller/processor 590 can be associated with the memory 580 that stores program codes and data. the memory 580 can be called a computer readable medium. Particularly, the X piece(s) of second-type information is(are) generated by the transmitting processor 555 in the UE 550 and mapped by the transmitter 556 to the antenna 560 in the form of RF signal(s). At the receiver end, each receiver 516 receives an RF signal of the X piece(s) of second-type information via a corresponding antenna 520, recovers baseband information modulated onto a radio frequency carrier, and provides the baseband information to the receiving processor 512.

In one embodiment, the first communication node (500) comprises at least one processor and at least one memory. The at least one memory includes computer program codes. The at least one memory and the computer program codes are configured to be used in collaboration with the at least one processor. The first communication node (550) at least receives X piece(s) of first-type information, X being a positive integer; transmits X radio signal(s); and transmits a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the first communication node (500) comprises a memory that stores a computer readable instruction program. The computer readable instruction program generates actions when executed by at least one processor. The actions include: receiving X piece(s) of first-type information, X being a positive integer; transmitting X radio signal(s); and transmitting a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the receiver 556 (comprising the antenna 560), the receiving processor 552 and the controller/processor 590 are used for receiving the X radio signal(s) in the present disclosure.

In one embodiment, the receiver 556 (comprising the antenna 560), the receiving processor 552 and the controller/processor 590 are used for receiving the first radio signal in the present disclosure.

In one embodiment, the receiver 556 (comprising the antenna 560), the receiving processor 552 and the controller/processor 590 are used for receiving the X signaling(s) in the present disclosure.

In one embodiment, the receiver 556 (comprising the antenna 560), the receiving processor 552 and the controller/processor 590 are used for receiving the second signaling in the present disclosure.

In one embodiment, the transmitter 556 (comprising the antenna 560), the transmitting processor 555 and the controller/processor 590 are used for transmitting the X piece(s) of second-type information in the present disclosure.

In one embodiment, the transmitter 516 (comprising the antenna 520), the transmitting processor 515 and the controller/processor 540 are used for transmitting the X radio signal(s) in the present disclosure.

In one embodiment, the transmitter 516 (comprising the antenna 520), the transmitting processor 515 and the controller/processor 540 are used for transmitting the first radio signal in the present disclosure.

In one embodiment, the transmitter 516 (comprising the antenna 520), the transmitting processor 515 and the controller/processor 540 are used for transmitting the X signaling(s) in the present disclosure.

In one embodiment, the transmitter 516 (comprising the antenna 520), the transmitting processor 515 and the controller/processor 540 are used for transmitting the second signaling in the present disclosure.

In one embodiment, the receiver 516 (comprising the antenna 520), the receiving processor 512 and the controller/processor 540 are used for receiving the X piece(s) of second-type information in the present disclosure.

### Embodiment 6

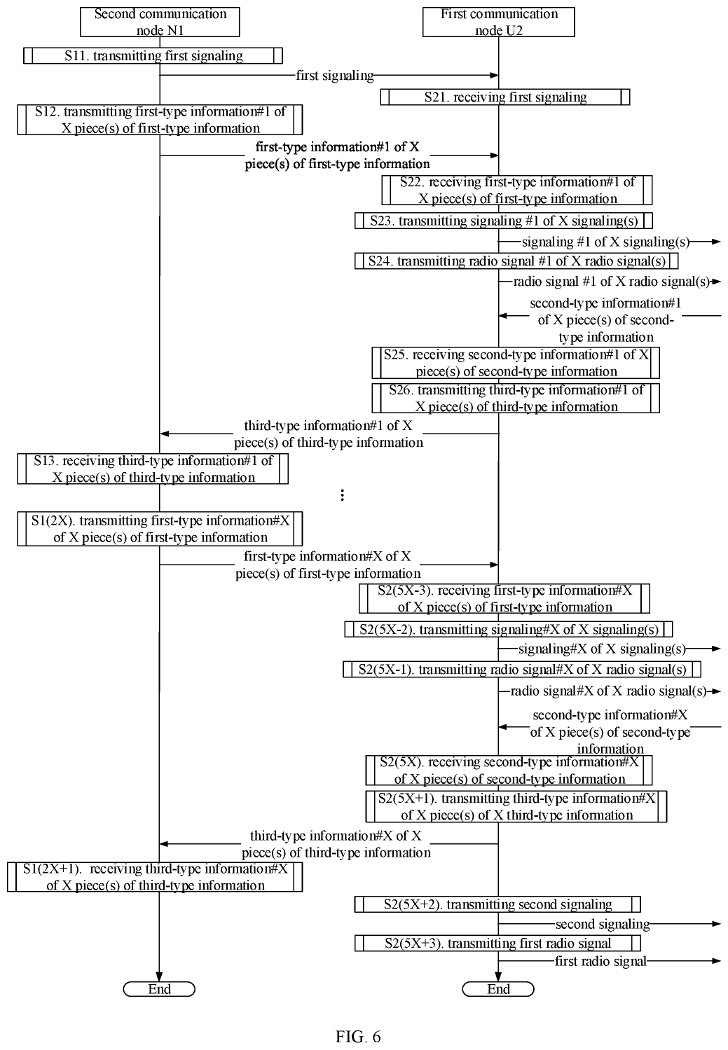

Embodiment 6 illustrates a flowchart of radio signal transmission according to one embodiment of the present disclosure, as shown in FIG. 6. In FIG. 6, a second communication node N1 is a maintenance base station for a serving cell of a first communication node U2.

The second communication node N1 transmits a first signaling in step S11, transmits first-type information#1 of X pieces of first-type information in step S12, and receives third-type information#1 of X pieces of third-type information in step S13, and then transmits first-type information#2, receives third-type information#2, transmits first-type information#3 and receives third-type information#3 . . . , till step S1(2X) in which N1 transmits first-type information#X of X pieces of first-type information, and step S1 (2X+1) in which N1 receives third-type information#X of X pieces of third-type information.

The first communication node U2 receives a first signaling in step S21, receives first-type information#1 of X pieces of first-type information in step S22, transmits signaling#1 of X signalings in step S23, and transmits radio signal#1 of X radio signals in step S24, receives second-type information#1 of X pieces of second-type information in step S25, transmits third-type information#1 of X pieces of third-type information in step S26, and then receives first-type information#2 of X pieces of first-type information, transmits signaling#2 of X signalings, transmits radio signal#2 of X radio signals, receives second-type information#2 of X pieces of second-type information, transmits third-type information#2 of X pieces of third-type information, receives first-type information#3 of X pieces of first-type information, transmits signaling#3 of X signalings, transmits radio signal#3 of X radio signals, receives second-type information#3 of X pieces of second-type information and transmits third-type information#3 of X pieces of third-type information . . . , until step S2(5X−3) in which the U2 receives first-type information#X of X pieces of first-type information, step S2(5X-2) in which the U2 transmits signaling#X of X signalings, and step S2(5X−1) in which the U2 transmits radio signal#X of X radio signals, step S2(5X) in which the U2 receives second-type information#X of X pieces of second-type information, and step S2(5X+1) in which the U2 transmits third-type information#X of X pieces of third-type information, step S2(5X+2) in which the U2 transmits a second signaling, and step S2(5X+3) in which the U2 transmits a first radio signal.

In Embodiment 6, X is a positive integer, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface; any of the X piece(s) of first-type information is transmitted via a first-type air interface; the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface; the X piece(s) of second-type information corresponds (correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface; the X piece(s) of third-type information corresponds (correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface; the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

In one embodiment, the first bit block comprises K bit sub-blocks, K being a positive integer greater than 1, the K bit sub-blocks are used for generating each radio signal of the X radio signal(s), and only K1 bit sub-block(s) of the K bit sub-blocks is(are) used for generating the first radio signal, K1 being a positive integer less than K, any bit sub-block of the K1 bit sub-block(s) being one of the K bit sub-blocks.

In one embodiment, the phrase that “the first signaling is used for indicating X” means that the first signaling is used for directly indicating X.

In one embodiment, the phrase that “the first signaling is used for indicating X” means that the first signaling is used for indirectly indicating X.

In one embodiment, the phrase that “the first signaling is used for indicating X” means that the first signaling is used for explicitly indicating X.

In one embodiment, the phrase that “the first signaling is used for indicating X” means that the first signaling is used for implicitly indicating X.

In one embodiment, the phrase that “the first signaling is used for indicating that the first communication node autonomously determines the scheduling information of the first radio signal” means that the first signaling is used for indicating that the first communication node is capable of autonomously determining the scheduling information of the first radio signal.

In one embodiment, the phrase that “the first signaling is used for indicating that the first communication node autonomously determines the scheduling information of the first radio signal” means that the first signaling is used for indicating that the first communication node is allowed to autonomously determine the scheduling information of the first radio signal.

In one embodiment, the phrase that “the first signaling is used for indicating that the first communication node autonomously determines the scheduling information of the first radio signal” means that the first signaling is used for directly indicating that the first communication node autonomously determines the scheduling information of the first radio signal.

In one embodiment, the phrase that “the first signaling is used for indicating that the first communication node autonomously determines the scheduling information of the first radio signal” means that the first signaling is used for indirectly indicating that the first communication node autonomously determines the scheduling information of the first radio signal.

In one embodiment, the phrase that “the first signaling is used for indicating that the first communication node autonomously determines the scheduling information of the first radio signal” means that the first signaling is used for explicitly indicating that the first communication node autonomously determines the scheduling information of the first radio signal.

In one embodiment, the phrase that “the first signaling is used for indicating that the first communication node autonomously determines the scheduling information of the first radio signal” means that the first signaling is used for implicitly indicating that the first communication node autonomously determines the scheduling information of the first radio signal.

In one embodiment, the phrase that “the first signaling is used for indicating that the first communication node autonomously determines the scheduling information of the first radio signal” means that the first signaling is an On/Off or an Enable/Disable signaling; when the first signaling indicates “on” or “enable”, the first communication node is allowed to determine the scheduling information of the first radio signal autonomously; when the first signaling indicates “off” or “disable”, the first communication node is not allowed to determine the scheduling information of the first radio signal autonomously.

In one embodiment, the phrase that “the first signaling is used for indicating X and that the first communication node autonomously determines the scheduling information of the first radio signal” means that the first signaling indicates the X and that the first communication node autonomously determines the scheduling information of the first radio signal in a way of Joint Coding.

In one embodiment, the phrase that “the first signaling is used for indicating X and that the first communication node autonomously determines the scheduling information of the first radio signal” means that the first signaling indicate X1, X1 being a non-negative integer; when X1 is equal to 0, the first signaling indicates that the first communication node is not allowed to autonomously determine scheduling information of the first radio signal; when X1 is greater than 0, X is equal to X1, the first signaling indicates that the first communication node is allowed to autonomously determine scheduling information of the first radio signal.

In one embodiment, the phrase that “the first signaling is used for indicating X and that the first communication node autonomously determines the scheduling information of the first radio signal” means that the first signaling indicate X1, X1 being a non-negative integer; when X1 is equal to 0, the first signaling indicates that the first communication node is incapable of determining scheduling information of the first radio signal autonomously; when X1 is greater than 0, X is equal to X1, the first signaling indicates that the first communication node is capable of determining scheduling information of the first radio signal autonomously.

In one embodiment, the phrase that “the first signaling is used for indicating X and that the first communication node autonomously determines the scheduling information of the first radio signal” means that the first signaling indicate X1, X1 being a non-negative integer; when X1 is equal to 0, the first signaling indicates that the first communication node is not allowed to autonomously determine scheduling information for a retransmission of the first bit block; when X1 is greater than 0, X is equal to X1, the first signaling indicates that the first communication node is allowed to autonomously determine scheduling information for a retransmission of the first bit block.

In one embodiment, the phrase that “any one of the X piece(s) of third-type information is used for indicating that a corresponding radio signal of the X radio signal(s) is not correctly received” means that any one of the X piece(s) of third-type information is used for indicating whether a corresponding radio signal of the X radio signal(s) is correctly received, and any of the X radio signal(s) is not correctly received.

In one embodiment, the phrase that “any one of the X piece(s) of third-type information is used for indicating that a corresponding radio signal of the X radio signal(s) is not correctly received” means that any one of the X piece(s) of third-type information is used for directly indicating that a corresponding radio signal of the X radio signal(s) is not correctly received.

In one embodiment, the phrase that “any one of the X piece(s) of third-type information is used for indicating that a corresponding radio signal of the X radio signal(s) is not correctly received” means that any one of the X piece(s) of third-type information is used for indirectly indicating that a corresponding radio signal of the X radio signal(s) is not correctly received.

In one embodiment, the phrase that “any one of the X piece(s) of third-type information is used for indicating that a corresponding radio signal of the X radio signal(s) is not correctly received” means that any one of the X piece(s) of third-type information is used for explicitly indicating that a corresponding radio signal of the X radio signal(s) is not correctly received.

In one embodiment, the phrase that “any one of the X piece(s) of third-type information is used for indicating that a corresponding radio signal of the X radio signal(s) is not correctly received” means that any one of the X piece(s) of third-type information is used for implicitly indicating that a corresponding radio signal of the X radio signal(s) is not correctly received.

### Embodiment 7

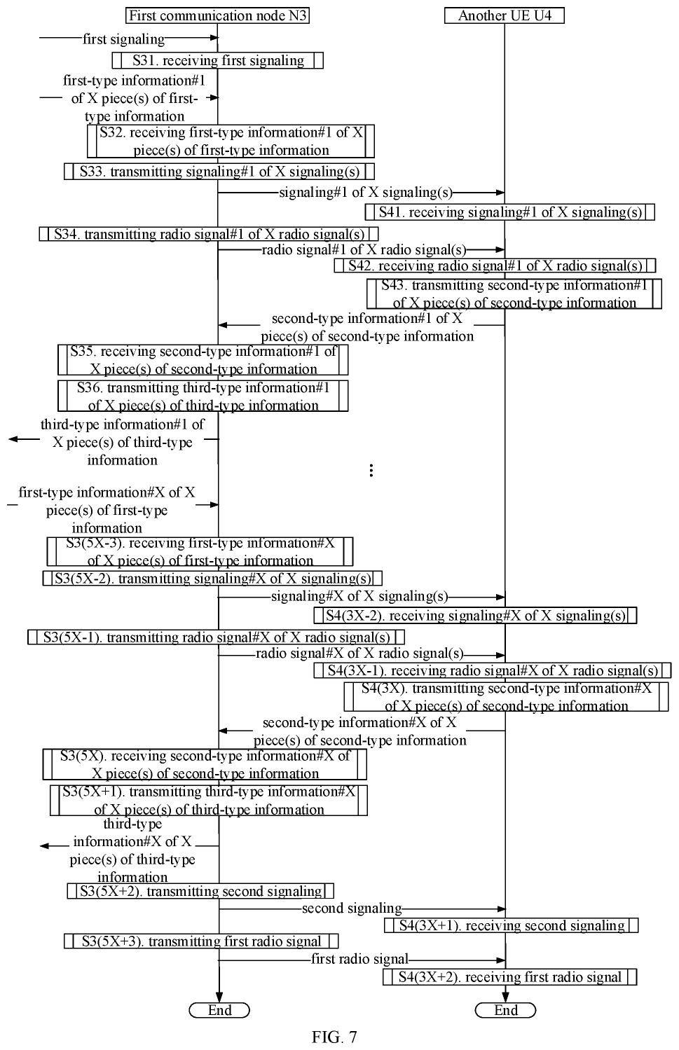

Embodiment 7 illustrates a flowchart of radio signal transmission according to another embodiment of the present disclosure, as shown in FIG. 7. In FIG. 7, a first communication node N3 is in communication with another UE U4.

The first communication node N3 receives a first signaling in step S31, receives first-type information#X of X pieces of first-type information in step S32, transmits signaling#1 of X signalings in step S33, and transmits radio signal#1 of X radio signals in step S34, receives second-type information#1 of X pieces of second-type information in step S35, and transmits third-type information#1 of X pieces of third-type information in step S36, and then receives first-type information#2 of X pieces of first-type information, transmits signaling#2 of the X signalings, transmits radio signal#2 of X radio signals, receives second-type information#2 of X pieces of second-type information and transmits third-type information#2 of X pieces of third-type information, and receives first-type information#3 of X pieces of first-type information, transmits signaling#3 of the X signalings, transmits radio signal#3 of X radio signals, receives second-type information#3 of X pieces of second-type information and transmits third-type information#3 of X pieces of third-type information . . . , till step S3(5X−3) in which N3 receives first-type information#X of X pieces of first-type information, step S3(5X−2) in which N3 transmits signaling#X of the X signalings, step S3(5X−1) in which N3 transmits radio signal#X of X radio signals, step S3(5X) in which N3 receives second-type information#X of X pieces of second-type information and step S3(5X+1) in which N3 transmits third-type information#X of X pieces of third-type information, step S3(5X+2) in which N3 transmits a second signaling and step S3(5X+3) in which N3 transmits a first radio signal.

The UE U4 receives signaling#1 of X signalings in step S41, receives radio signal#1 of X radio signals in step S42, and transmits second-type information#1 of X pieces of second-type information in step S43, and then receives signaling#2 of X signalings, receives radio signal#2 of X radio signals, and transmits second-type information#2 of X pieces of second-type information, receives signaling#3 of X signalings, receives radio signal#3 of X radio signals, and transmits second-type information#3 of X pieces of second-type information . . . , till step S4(3X−2) in which the U4 receives signaling#X of the X signalings, step S4(3X−1) in which the U4 receives radio signal #X of X radio signals, step S4(3X) in which the U4 transmits second-type information#X of X pieces of second-type information, step S4(3X+1) in which the U4 receives a second signaling, and step S4(3X+2) in which the U4 receives a first radio signal.

In Embodiment 7, X is a positive integer, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface; any of the X piece(s) of first-type information is transmitted via a first-type air interface; the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface; the X piece(s) of second-type information corresponds(correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface; the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface; the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

In one embodiment, the phrase that “any one of the X piece(s) of second-type information is used for indicating that a corresponding radio signal of the X radio signal(s) is not correctly received” means that any one of the X piece(s) of second-type information is used for indicating whether a corresponding radio signal of the X radio signal(s) is correctly received, and any of the X radio signal(s) is not correctly received.

In one embodiment, the phrase that “any one of the X piece(s) of second-type information is used for indicating that a corresponding radio signal of the X radio signal(s) is not correctly received” means that any one of the X piece(s) of second-type information is used for directly indicating that a corresponding radio signal of the X radio signal(s) is not correctly received.

In one embodiment, the phrase that “any one of the X piece(s) of second-type information is used for indicating that a corresponding radio signal of the X radio signal(s) is not correctly received” means that any one of the X piece(s) of second-type information is used for indirectly indicating that a corresponding radio signal of the X radio signal(s) is not correctly received.

In one embodiment, the phrase that “any one of the X piece(s) of second-type information is used for indicating that a corresponding radio signal of the X radio signal(s) is not correctly received” means that any one of the X piece(s) of second-type information is used for explicitly indicating that a corresponding radio signal of the X radio signal(s) is not correctly received.

In one embodiment, the phrase that “any one of the X piece(s) of second-type information is used for indicating that a corresponding radio signal of the X radio signal(s) is not correctly received” means that any one of the X piece(s) of second-type information is used for implicitly indicating that a corresponding radio signal of the X radio signal(s) is not correctly received.

In one embodiment, the phrase that “the X signaling(s) is(are respectively) used for indicating the scheduling information of the X radio signal(s)” means that the X signaling(s) is(are respectively) used for directly indicating the scheduling information of the X radio signal(s).

In one embodiment, the phrase that “the X signaling(s) is(are respectively) used for indicating the scheduling information of the X radio signal(s)” means that the X signaling(s) is(are respectively) used for indirectly indicating the scheduling information of the X radio signal(s).

In one embodiment, the phrase that “the X signaling(s) is(are respectively) used for indicating the scheduling information of the X radio signal(s)” means that the X signaling(s) is(are respectively) used for explicitly indicating the scheduling information of the X radio signal(s).

In one embodiment, the phrase that “the X signaling(s) is(are respectively) used for indicating the scheduling information of the X radio signal(s)” means that the X signaling(s) is(are respectively) used for implicitly indicating the scheduling information of the X radio signal(s).

In one embodiment, the phrase that “the second signaling is used for indicating the scheduling information of the first radio signal” means that the second signaling is used for directly indicating the scheduling information of the first radio signal.

In one embodiment, the phrase that “the second signaling is used for indicating the scheduling information of the first radio signal” means that the second signaling is used for indirectly indicating the scheduling information of the first radio signal.

In one embodiment, the phrase that “the second signaling is used for indicating the scheduling information of the first radio signal” means that the second signaling is used for explicitly indicating the scheduling information of the first radio signal.

In one embodiment, the phrase that “the second signaling is used for indicating the scheduling information of the first radio signal” means that the second signaling is used for implicitly indicating the scheduling information of the first radio signal.

In one embodiment, a target receiver of the X signaling(s) is the same as a target receiver of the second signaling.

### Embodiment 8

Embodiment 8 illustrates a schematic diagram of a first signaling according to one embodiment of the present disclosure, as shown in FIG. 8. In FIG. 8, the first column on the left illustrates the content of a first signaling, and the second column on the left illustrates the behavior of a first communication node.

In Embodiment 8, the first signaling in the present disclosure indicates X1, X1 being a non-negative integer; the first signaling indicate X1, X1 being a non-negative integer; when X1 is equal to 0, the first signaling indicates that the first communication node in the present disclosure is not allowed to autonomously determine scheduling information of the first radio signal in the present disclosure; when X1 is greater than 0, the X in the present disclosure is equal to X1, the first signaling indicates that the first communication node is allowed to autonomously determine scheduling information of the first radio signal.

In one embodiment, the first signaling is a higher layer signaling.

In one embodiment, the first signaling is a physical layer signaling.

In one embodiment, the first signaling comprises all or part of a higher layer signaling.

In one embodiment, the first signaling comprises all or part of a physical layer signaling.

In one embodiment, the first signaling is transmitted through a Downlink Shared Channel (DL-SCH).

In one embodiment, the first signaling is transmitted through a Physical Downlink Shared Channel (PDSCH).

In one embodiment, the first signaling comprises all or part of Information Elements (IEs) in an RRC signaling.

In one embodiment, the first signaling comprises all or part of fields of an IE in an RRC signaling.

In one embodiment, the first signaling comprises one or more fields of a System Information Block (SIB).

In one embodiment, the first signaling is broadcast.

In one embodiment, the first signaling is unicast.

In one embodiment, the first signaling is Cell Specific.

In one embodiment, the first signaling is UE-specific.

In one embodiment, the first signaling is transmitted through a PDCCH.

In one embodiment, the first signaling comprises all or part of fields of a DCI signaling.

### Embodiment 9

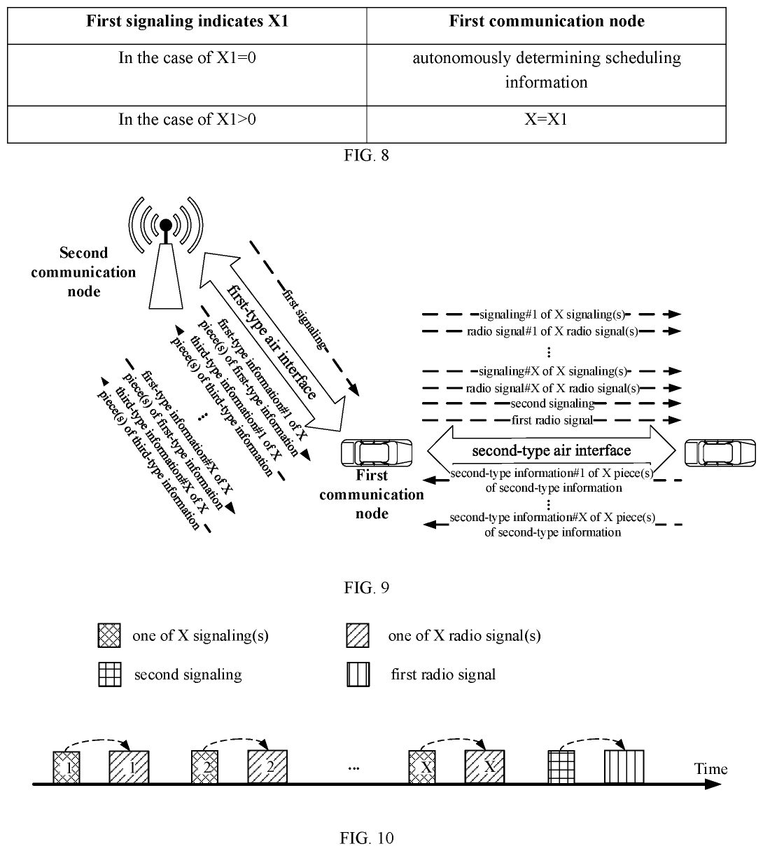

Embodiment 9 illustrates a schematic diagram of relations of X piece(s) of second-type information, X piece(s) of third-type information and X radio signal(s) according to one embodiment of the present disclosure, as shown in FIG. 9. In FIG. 9, a first communication node represents a vehicle-mounted UE (e.g., vehicle-mounted communication unit), and a second communication node represents a base station (e.g., gNB or eNB); each broken-line arrow represents a signaling or a signal or a piece of information.

In Embodiment 9, the X piece(s) of second-type information corresponds(correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface; the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

In one embodiment, any of the X piece(s) of second-type information comprises physical layer information.

In one embodiment, any of the X piece(s) of second-type information comprises higher layer information.

In one embodiment, any of the X piece(s) of second-type information is transmitted via a physical layer signaling.

In one embodiment, any of the X piece(s) of second-type information is transmitted via a higher layer signaling.

In one embodiment, any of the X piece(s) of second-type information comprises all or part of a piece of higher layer information.

In one embodiment, any of the X piece(s) of second-type information comprises all or part of a piece of physical layer information.

In one embodiment, any of the X piece(s) of second-type information is transmitted through an SL-SCH.

In one embodiment, any of the X piece(s) of second-type information is transmitted through a PSSCH.

In one embodiment, any of the X piece(s) of second-type information is transmitted through a Physical Sidelink Feedback Channel (PSFCH).

In one embodiment, any of the X piece(s) of second-type information is transmitted through a Physical Sidelink Control Channel (PSCCH).

In one embodiment, any of the X piece(s) of second-type information is broadcast.

In one embodiment, any of the X piece(s) of second-type information is unicast.

In one embodiment, any of the X piece(s) of second-type information comprises all or part of fields of a Sidelink Control Information (SCI) signaling

In one embodiment, any of the X piece(s) of second-type information comprises all or part of fields of a Sidelink Feedback Control Information (SFCI) signaling.

In one embodiment, any two of the X pieces of second-type information carry same contents, X being greater than 1.

In one embodiment, there are two pieces of second-type information among the X pieces of second-type information that carry same contents, X being greater than 1.

In one embodiment, among the X pieces of second-type information there are two pieces of second-type information respectively comprising one field that carry same contents, X being greater than 1.

In one embodiment, among the X pieces of second-type information any two pieces of second-type information respectively comprise one field that carry same contents, X being greater than 1.

In one embodiment, any of the X piece(s) of second-type information carries ACK/NACK information for the first bit block.

In one embodiment, any of the X piece(s) of second-type information carries HARQ information for the first bit block.

In one embodiment, any of the X piece(s) of second-type information carries ACK/NACK information for part of bits comprised in the first bit block.

In one embodiment, any of the X piece(s) of second-type information carries HARQ information for part of bits comprised in the first bit block.

In one embodiment, the X piece(s) of second-type information corresponds(correspond) to the X radio signal(s) respectively.

In one embodiment, start times of reception of the X pieces of second-type information and start times of transmission of the X radio signals are interleaved in time domain.

In one embodiment, a transmitter of the X piece(s) of second-type information is a UE.

In one embodiment, a transmitter of the X piece(s) of second-type information is a UE other than the first communication node.

In one embodiment, a transmitter of the X piece(s) of second-type information is vehicle-mounted equipment other than the first communication node.

In one embodiment, a transmitter of the X piece(s) of second-type information is a UE supporting V2X communications other than the first communication node.

In one embodiment, a transmitter of the X piece(s) of second-type information is in coverage of a transmitter of the X piece(s) of first-type information.

In one embodiment, a transmitter of the X piece(s) of second-type information is out of coverage of a transmitter of the X piece(s) of first-type information.

In one embodiment, the second-type air interface is a radio interface employed for communication of the first communication node and another UE.

In one embodiment, the second-type air interface is a PC5 interface.

In one embodiment, the second-type air interface is a radio interface between UEs.

In one embodiment, the second-type air interface is a radio interface of sidelink transmission.

In one embodiment, the X pieces of third-type information are received by a same target receiver.

In one embodiment, a target receiver of the X piece(s) of third-type information is a transmitter of the X piece(s) of first-type information.

In one embodiment, any of the X piece(s) of third-type information comprises physical layer information.

In one embodiment, any of the X piece(s) of third-type information comprises higher layer information.

In one embodiment, any of the X piece(s) of third-type information is transmitted via a physical layer signaling.

In one embodiment, any of the X piece(s) of third-type information is transmitted via a higher layer signaling.

In one embodiment, any of the X piece(s) of third-type information comprises all or part of a pieces of higher layer information.

In one embodiment, any of the X piece(s) of third-type information comprises all or part of a pieces of physical layer information.

In one embodiment, any of the X piece(s) of third-type information is transmitted through an Uplink Shared Channel (UL-SCH).

In one embodiment, any of the X piece(s) of third-type information is transmitted through a Physical Uplink Shared Channel (PUSCH).

In one embodiment, any of the X piece(s) of third-type information is transmitted through a PUSCH's piggyback.

In one embodiment, any of the X piece(s) of third-type information is unicast.

In one embodiment, any of the X piece(s) of third-type information is UE-specific.

In one embodiment, any of the X piece(s) of third-type information is transmitted through a Physical Uplink Control Channel (PUCCH).

In one embodiment, any of the X piece(s) of third-type information comprises all or part of fields of an Uplink Control Information (UCI) signaling.

In one embodiment, any of the X piece(s) of third-type information comprises all or part of fields of a UCI signaling used for sidelink.

In one embodiment, there are two pieces of third-type information among the X pieces of third-type information that carry same contents, X being greater than 1.

In one embodiment, among the X pieces of third-type information there are two pieces of third-type information respectively comprising one field that carry same contents, X being greater than 1.

In one embodiment, among the X pieces of third-type information any two pieces of third-type information respectively comprise one field that carry same contents, X being greater than 1.

In one embodiment, any of the X piece(s) of third-type information is a piece of HARQ-ACK information.

In one embodiment, any of the X piece(s) of third-type information is a piece of HARQ-ACK information for sidelink transmission.

In one embodiment, any of the X piece(s) of third-type information carries ACK/NACK information for the first bit block.

In one embodiment, any of the X piece(s) of third-type information carries HARQ information for the first bit block.

In one embodiment, start times of reception of the X pieces of third-type information and start times of transmission of the X radio signals are interleaved in time domain.

In one embodiment, the X piece(s) of third-type information is(are respectively) forwarding of the X piece(s) of second-type information.

In one embodiment, the X piece(s) of third-type information is(are respectively) duplicate of the X piece(s) of second-type information.

In one embodiment, information carried by any of the X piece(s) of third-type information is the same as information carried by one of the X piece(s) of second-type information.

### Embodiment 10

Embodiment 10 illustrates a schematic diagram of relations of X signaling(s), X radio signal(s), a second signaling and a first radio signal according to one embodiment of the present disclosure, as shown in FIG. 10. In FIG. 10, the horizontal axis represents time, each cross-filled rectangle represents one of X signaling(s), each slash-filled rectangle represents one of X radio signal(s), the gridline-filled rectangle represents a second signaling, and the vertical-line-filled rectangle represents a first radio signal.

In Embodiment 10, the X signaling(s) in the present disclosure is(are respectively) used for indicating the scheduling information of the X radio signal(s) in the present disclosure, and the second signaling in the present disclosure is used for indicating the scheduling information of the first radio signal in the present disclosure; the X piece(s) of first-type information is(are respectively) used for determining the X signaling(s); and a target receiver of the X signaling(s) and the second signaling is different from the transmitter of the X piece(s) of first-type information.

In one embodiment, any of the X signaling(s) comprises physical layer information.

In one embodiment, any of the X signaling(s) is a physical layer signaling transmission.

In one embodiment, any of the X signaling(s) comprises all or part of a piece of physical layer information.

In one embodiment, any of the X signaling(s) is broadcast.

In one embodiment, any of the X signaling(s) is groupcast.

In one embodiment, any of the X signaling(s) is unicast.

In one embodiment, any of the X signaling(s) is Cell Specific.

In one embodiment, any of the X signaling(s) is UE-specific.

In one embodiment, any of the X signaling(s) is transmitted through a PSCCH.

In one embodiment, any of the X signaling(s) comprises all or part of fields of an SCI signaling.

In one embodiment, the X signaling(s) respectively comprises(comprise) Scheduling Assignment(s) (SA(s)) of the X radio signal(s).

In one embodiment, the second signaling comprises physical layer information.

In one embodiment, the second signaling is a physical layer signaling transmission.

In one embodiment, the second signaling comprises all or part of a piece of physical layer information.

In one embodiment, the second signaling is broadcast.

In one embodiment, the second signaling is groupcast.

In one embodiment, the second signaling is unicast.

In one embodiment, the second signaling is Cell Specific.

In one embodiment, the second signaling is UE-specific.

In one embodiment, the second signaling is transmitted through a PSCCH.

In one embodiment, the second signaling comprises all or part of fields of an SCI signaling.

In one embodiment, the second signaling comprises a Scheduling Assignment (SA) of the first radio signal.

In one embodiment, a target receiver of the X signaling(s) and the second signaling is the same as a transmitter of the X piece(s) of second-type information in the present disclosure.

In one embodiment, a target receiver of the X signaling(s) and the second signaling is the same as a target receiver of the X radio signal(s) in the present disclosure.

In one embodiment, a target receiver of the X signaling(s) and the second signaling is the same as a target receiver of the first radio signal in the present disclosure.

In one embodiment, the X signaling(s) and the second signaling are transmitted through the second-type air interface in the present disclosure.

In one embodiment, the phrase that “the X piece(s) of first-type information is(are respectively) used for determining the X signaling(s)” includes a meaning that the X piece(s) of first-type information is(are respectively) used for determining all information carried by the X signaling(s).

In one embodiment, the phrase that “the X piece(s) of first-type information is(are respectively) used for determining the X signaling(s)” includes a meaning that the X piece(s) of first-type information is(are respectively) used for determining part of information carried by the X signaling(s).

In one embodiment, the phrase that “the X piece(s) of first-type information is(are respectively) used for determining the X signaling(s)” includes a meaning that the X signaling(s) respectively carries(carry) all or part of the X piece(s) of first-type information.

In one embodiment, the phrase that “the X piece(s) of first-type information is(are respectively) used for determining the X signaling(s)” includes a meaning that the X signaling(s) respectively forwards(forward) all or part of the X piece(s) of first-type information.

In one embodiment, the phrase that “the X piece(s) of first-type information is(are respectively) used for determining the X signaling(s)” includes a meaning that all or part of the X piece(s) of first-type information is(are respectively) duplicated in the X signaling(s).

In one embodiment, the phrase that “the X piece(s) of first-type information is(are respectively) used for determining the X signaling(s)” includes a meaning that the X piece(s) of first-type information is(are respectively) used by the first communication node for determining the X signaling(s).

In one embodiment, the phrase that “the X piece(s) of first-type information is(are respectively) used for determining the X signaling(s)” includes a meaning that the X piece(s) of first-type information is(are respectively) used for directly indicating the X signaling(s).

In one embodiment, the phrase that “the X piece(s) of first-type information is(are respectively) used for determining the X signaling(s)” includes a meaning that the X piece(s) of first-type information is(are respectively) used for indirectly indicating the X signaling(s).

In one embodiment, the phrase that “the X piece(s) of first-type information is(are respectively) used for determining the X signaling(s)” includes a meaning that the X piece(s) of first-type information is(are respectively) used for explicitly indicating the X signaling(s).

In one embodiment, the phrase that “the X piece(s) of first-type information is(are respectively) used for determining the X signaling(s)” includes a meaning that the X piece(s) of first-type information is(are respectively) used for implicitly indicating the X signaling(s).

In one embodiment, the phrase that “the X piece(s) of first-type information is(are respectively) used for determining the X signaling(s)” includes a meaning that the X piece(s) of first-type information is(are) first conveyed to a higher layer and then the higher layer determines the X signaling(s) based on the X piece(s) of first-type information.

### Embodiment 11

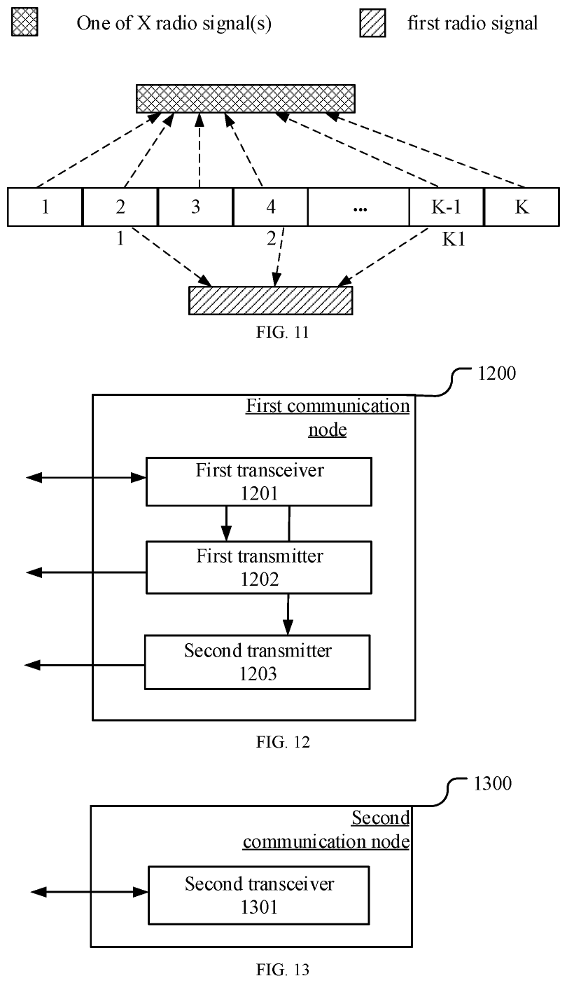

Embodiment 11 illustrates a schematic diagram of relations of X radio signal(s) and a first radio signal according to one embodiment of the present disclosure, as shown in FIG. 11. In FIG. 11, the cross-filled rectangle represents one of X radio signal(s), the slash-filled rectangle represents a first radio signal, and each blank rectangle marked with a number internally represents one of K bit sub-blocks.

In Embodiment 11, the first bit block in the present disclosure comprises K bit sub-blocks, K being a positive integer greater than 1, the K bit sub-blocks are used for generating each of the X radio signal(s) in the present disclosure, and only K1 bit sub-block(s) of the K bit sub-blocks is(are) used for generating the first radio signal in the present disclosure, K1 being a positive integer less than K, any bit sub-block of the K1 bit sub-block(s) being one of the K bit sub-blocks.

In one embodiment, the K bit sub-blocks make up the first bit block.

In one embodiment, the first bit block also comprises bits other than the K bit sub-blocks.

In one embodiment, bits comprised in the first bit block are divided into the K bit sub-blocks according to respective orders in the first bit block.

In one embodiment, numbers of bits respectively comprised in any two of the K bit sub-blocks are equal.

In one embodiment, there are two bit sub-blocks of the K bit sub-blocks that comprise unequal numbers of bits.

In one embodiment, there are two bit sub-blocks of the K bit sub-blocks that comprise equal numbers of bits.

In one embodiment, there is one bit sub-block among the K bit sub-blocks that comprises Padding Bits.

In one embodiment, there isn't any bit sub-block among the K bit sub-blocks that comprises Padding

Bits.

In one embodiment, the first bit block comprises Padding Bits.

In one embodiment, the first bit block does not comprise Padding Bits.

In one embodiment, any of the K bit sub-blocks is a Code Block Group (CBG).

In one embodiment, any of the K bit sub-blocks comprises one or more Code Blocks (CBs).

In one embodiment, any of the K bit sub-blocks comprises a positive integer number of bit(s).

In one embodiment, the phrase that “the K bit sub-blocks are used for generating each radio signal of the X radio signal(s)” includes a meaning that each of the X radio signal(s) is generated by the K bit sub-blocks sequentially through Code Block-level (CB-level) CRC Insertion, Channel Coding, Rate Matching and Concatenation, and then sequentially through Scrambling, Modulation, Transform Precoding, Layer Mapping and Precoding, Mapping to Virtual Resource Blocks, Mapping from Virtual to Physical Resource Blocks and OFDM Baseband Signal Generation, as well as Modulation and Upconversion. In one subsidiary embodiment of the above embodiment, among the X radio signals there are two radio signals of a same Redundancy Version (RV) in the Rate Matching procedure. In one subsidiary embodiment of the above embodiment, among the X radio signals there aren't two radio signals of a same Redundancy Version (RV) in the Rate Matching procedure.

In one embodiment, the phrase that “the K bit sub-blocks are used for generating each radio signal of the X radio signal(s)” includes a meaning that each of the X radio signal(s) is generated by the K bit sub-blocks sequentially through CB-level CRC Insertion, Channel Coding, Rate Matching and Concatenation, and then sequentially through Scrambling, Modulation, Layer Mapping, and Precoding, Mapping to Virtual Resource Blocks, Mapping from Virtual to Physical Resource Blocks and OFDM Baseband Signal Generation, as well as Modulation and Upconversion. In one subsidiary embodiment of the above embodiment, among the X radio signals there are two radio signals of a same Redundancy Version (RV) in the Rate Matching procedure. In one subsidiary embodiment of the above embodiment, among the X radio signals there aren't two radio signals of a same Redundancy Version (RV) in the Rate Matching procedure.

In one embodiment, the phrase that “only K1 bit sub-block(s) of the K bit sub-blocks is(are) used for generating the first radio signal” includes a meaning that each of the X radio signal(s) is generated by only K1 bit sub-block(s) of the K bit sub-blocks sequentially through CB-level CRC Insertion, Channel Coding, Rate Matching and Concatenation, and then sequentially through Scrambling, Transform Precoding, Modulation, Layer Mapping and Precoding, Mapping to Virtual Resource Blocks, Mapping from Virtual to Physical Resource Blocks and OFDM Baseband Signal Generation, and Modulation and Upconversion.

In one embodiment, the phrase that “only K1 bit sub-block(s) of the K bit sub-blocks is(are) used for generating the first radio signal” includes a meaning that each of the X radio signal(s) is generated by only K1 bit sub-block(s) of the K bit sub-blocks sequentially through CB-level CRC Insertion, Channel Coding, Rate Matching and Concatenation, and then sequentially through Scrambling, Modulation, Layer Mapping, and Precoding, Mapping to Virtual Resource Blocks, Mapping from Virtual to Physical Resource Blocks and OFDM Baseband Signal Generation, and Modulation and Upconversion.

### Embodiment 12

Embodiment 12 illustrates a structure block diagram of a processing device in a first communication node according to one embodiment, as shown in FIG. 12. In FIG. 12, a processing device 1200 in a first communication node comprises a first transceiver 1201, a first transmitter 1202 and a second transmitter. The first transceiver 1201 comprises the transmitter/receiver 456 (comprising the antenna 460), the receiving processor 452, the transmitting processor 455 and the controller/processor 490 in FIG. 4 of the present disclosure; or the first transceiver 1201 comprises the transmitter/receiver 516 (comprising the antenna 520), the receiving processor 512, the transmitting processor 515 and the controller/processor 540 in FIG. 5 of the present disclosure; the first transmitter 1202 comprises the transmitter/receiver 456 (comprising the antenna 460), the transmitting processor 455 and the controller/processor 490 in FIG. 4 of the present disclosure; or the first transmitter 1202 comprises the transmitter/receiver 516 (comprising the antenna 520), the transmitting processor 515 and the controller/processor 540 in FIG. 5 of the present disclosure; the second transmitter 1203 comprises the transmitter/receiver 456 (comprising the antenna 460), the transmitting processor 455 and the controller/processor 490 in FIG. 4 of the present disclosure; or the second transmitter 1203 comprises the transmitter/receiver 516 (comprising the antenna 520), the transmitting processor 515 and the controller/processor 540 in FIG. 5 of the present disclosure.

In Embodiment 12, the first transceiver 1201 receives X piece(s) of first-type information, X being a positive integer; the first transmitter 1202 transmits X radio signal(s); and the second transmitter 1203 transmits a first radio signal; herein, a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the first transceiver 1201 also receives a first signaling; herein, the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface.

In one embodiment, the first transceiver 1201 also receives X piece(s) of second-type information; herein, the X piece(s) of second-type information corresponds(correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface.

In one embodiment, the first transceiver 1201 also transmits X piece(s) of third-type information; herein, the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

In one embodiment, the first transceiver 1201 also transmits X signaling(s) and a second signaling; herein, the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

In one embodiment, the first bit block comprises K bit sub-blocks, K being a positive integer greater than 1, the K bit sub-blocks are used for generating each radio signal of the X radio signal(s), and only K1 bit sub-block(s) of the K bit sub-blocks is(are) used for generating the first radio signal, K1 being a positive integer less than K, any bit sub-block of the K1 bit sub-block(s) being one of the K bit sub-blocks.

### Embodiment 13

Embodiment 13 illustrates a structure block diagram of a processing device in a second communication node according to one embodiment, as shown in FIG. 13. In FIG. 13, a processing device 1300 in a second communication node comprises a second transceiver 1301. The second transceiver 1301 comprises the transmitter/receiver 416 (comprising the antenna 420), the receiving processor 412, the transmitting processor 415 and the controller/processor 440.

In Embodiment 13, the second transceiver 1301 transmits X piece(s) of first-type information, X being a positive integer; herein, the X piece(s) of first-type information is(are respectively) used for determining scheduling information of the X radio signal(s); a first bit block is used for generating any radio signal of the X radio signal(s), and the first bit block is also used for generating the first radio signal, the first bit block comprising a positive integer number of bit(s); a transmitter of the first radio signal autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

In one embodiment, the second transceiver 1301 also transmits a first signaling; herein, the first signaling is used for indicating X, or the first signaling is used for indicating that a transmitter of the first radio signal autonomously determines the scheduling information of the first radio signal, or the first signaling is used for indicating X and that the transmitter of the first radio signal autonomously determines the scheduling information of the first radio signal; the first signaling is transmitted via the first-type air interface.

In one embodiment, the second transceiver 1301 also receives X piece(s) of third-type information; herein, the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

In one embodiment, the first bit block comprises K bit sub-blocks, K being a positive integer greater than 1, the K bit sub-blocks are used for generating each radio signal of the X radio signal(s), and only K1 bit sub-block(s) of the K bit sub-blocks is(are) used for generating the first radio signal, K1 being a positive integer less than K, any bit sub-block of the K1 bit sub-block(s) being one of the K bit sub-blocks.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The first-type communication node or UE or terminal includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The second-type communication node or base station or network equipment in the present disclosure includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first communication node for wireless communications, comprising:
a first transceiver, receiving X piece(s) of first-type information, X being a positive integer;
a first transmitter, transmitting X radio signal(s); and
a second transmitter, transmitting a first radio signal;
wherein a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed Modulation and Coding Scheme (MCS) or an employed Redundancy Version (RV); any of the X piece(s) of first-type information is transmitted via a first-type air interface.

2. The first communication node according to claim 1, wherein the first transceiver also receives a first signaling; wherein the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface.

3. The first communication node according to claim 1, wherein the first transceiver also receives X piece(s) of second-type information; wherein the X piece(s) of second-type information corresponds(correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface.

4. The first communication node according to claim 1, wherein the first transceiver also transmits X piece(s) of third-type information; wherein the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

5. The first communication node according to claim 1, wherein the first transceiver also transmits X signaling(s) and a second signaling; wherein the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

6. The first communication node according to claim 1, wherein the first bit block comprises K bit sub-blocks, K being a positive integer greater than 1, the K bit sub-blocks are used for generating each radio signal of the X radio signal(s), and only K1 bit sub-block(s) out of the K bit sub-blocks is(are) used for generating the first radio signal, K1 being a positive integer less than K, any bit sub-block of the K1 bit sub-block(s) being one of the K bit sub-blocks.

7. The first communication node according to claim 1, wherein each of the X radio signal(s) belongs to a same Hybrid Automatic Repeat Request (HARQ) process, any radio signal of the X radio signal(s) is transmitted through a Sidelink Shared Channel, and the first radio signal is a retransmission of all or part of bits in the first bit block.

8. The first communication node according to claim 1, wherein the first radio signal is obtained by the first bit block sequentially through CRC Insertion, Segmentation, Code Block (CB)-level CRC Insertion, Channel Coding, Rate Matching, Concatenation, Scrambling, Modulation, Layer Mapping, Precoding, Mapping to Virtual Resource Blocks, and Mapping from Virtual to Physical Resource Blocks, OFDM Baseband Signal Generation, and Modulation and Upconversion.

9. The first communication node according to claim 1, wherein contents carried by fields used for indicating a HARQ process respectively comprised in any two of the X pieces of first-type information are the same, X being a positive integer greater than 1; start times of transmissions of the X pieces of first-type information and start times of transmissions of the X radio signals are interleaved in time domain.

10. The first communication node according to claim 2, wherein the first signaling indicates X1, X1 being a non-negative integer; when X1 is equal to 0, the first signaling indicates that the first communication node is not allowed to autonomously determine scheduling information for a retransmission of the first bit block; when X1 is greater than 0, X is equal to X1, and the first signaling indicates that the first communication node is allowed to autonomously determine the scheduling information for the retransmission of the first bit block.

11. A method in a first communication node for wireless communications, comprising:
receiving X piece(s) of first-type information, X being a positive integer;
transmitting X radio signal(s); and
transmitting a first radio signal;
wherein a first bit block is used for generating any radio signal of the X radio signal(s), and the first bit block is also used for generating the first radio signal, the first bit block comprising a positive integer number of bit(s); the X piece(s) of first-type information is(are respectively) used for determining scheduling information of the X radio signal(s); the first communication node autonomously determines scheduling information of the first radio signal, and a start time of a transmission of the first radio signal is later than an end time of a transmission of any one of the X radio signal(s); the scheduling information comprises at least one of an occupied time-frequency resource, an employed MCS or an employed RV; any of the X piece(s) of first-type information is transmitted via a first-type air interface.

12. The method in the first communication node according to claim 11, comprising:
receiving a first signaling;
wherein the first signaling is used for indicating X, or the first signaling is used for indicating that the first communication node autonomously determines the scheduling information of the first radio signal, or the first signaling is used for indicating X and that the first communication node autonomously determines the scheduling information of the first radio signal; the first signaling is transmitted via the first-type air interface.

13. The method in the first communication node according to claim 11, comprising:
receiving X piece(s) of second-type information;
wherein the X piece(s) of second-type information corresponds(correspond) to the X radio signal(s) respectively, and any one of the X piece(s) of second-type information is used for indicating that a corresponding radio signal of the X radio signal(s) is not correctly received, a transmitter of the X piece(s) of second-type information is different from a transmitter of the X piece(s) of first-type information, any of the X piece(s) of second-type information is transmitted via a second-type air interface, and the second-type air interface is different from the first-type air interface.

14. The method in the first communication node according to claim 11, comprising:
transmitting X piece(s) of third-type information;
wherein the X piece(s) of third-type information corresponds(correspond) to the X radio signal(s) respectively, any one of the X piece(s) of third-type information is used for indicating that a corresponding radio signal of the X radio signal(s) is not correctly received, and any of the X piece(s) of third-type information is transmitted via the first-type air interface.

15. The method in the first communication node according to claim 11, comprising:
transmitting X signaling(s) and a second signaling;
wherein the X signaling(s) is(are respectively) used for indicating the scheduling information of the X radio signal(s), and the second signaling is used for indicating the scheduling information of the first radio signal; the X piece(s) of first-type information is(are respectively) used for determining the X signaling(s); and a target receiver of the X signaling(s) and the second signaling is different from the transmitter of the X piece(s) of first-type information.

16. The method in the first communication node according to claim 11, wherein the first bit block comprises K bit sub-blocks, K being a positive integer greater than 1, the K bit sub-blocks are used for generating each radio signal of the X radio signal(s), and only K1 bit sub-block(s) out of the K bit sub blocks is(are) used for generating the first radio signal, K1 being a positive integer less than K, any bit sub-block of the K1 bit sub-block(s) being one of the K bit sub-blocks.

17. The method in the first communication node according to claim 11, wherein each of the X radio signal(s) belongs to a same Hybrid Automatic Repeat Request (HARQ) process, any radio signal of the X radio signal(s) is transmitted through a Sidelink Shared Channel, and the first radio signal is a retransmission of all or part of bits in the first bit block.

18. The method in the first communication node according to claim 11, wherein the first radio signal is obtained by the first bit block sequentially through CRC Insertion, Segmentation, Code Block (CB)-level CRC Insertion, Channel Coding, Rate Matching, Concatenation, Scrambling, Modulation, Layer Mapping, Precoding, Mapping to Virtual Resource Blocks, and Mapping from Virtual to Physical Resource Blocks, OFDM Baseband Signal Generation, and Modulation and Upconversion.

19. The method in the first communication node according to claim 11, wherein contents carried by fields used for indicating a HARQ process respectively comprised in any two of the X pieces of first-type information are the same, X being a positive integer greater than 1; start times of transmissions of the X pieces of first-type information and start times of transmissions of the X radio signals are interleaved in time domain.

20. The method in the first communication node according to claim 12, wherein the first signaling indicates X1, X1 being a non-negative integer; when X1 is equal to 0, the first signaling indicates that the first communication node is not allowed to autonomously determine scheduling information for a retransmission of the first bit block; when X1 is greater than 0, X is equal to X1, and the first signaling indicates that the first communication node is allowed to autonomously determine the scheduling information for the retransmission of the first bit block.
